(19) United States
(12) Patent Application Publication
(10) Pub. No.: US 2003/0106768 A1
(43) Pub. Date: Jun. 12, 2003

(54) Chute positioning apparatus

(76) Inventor: Kuo-Chin Huang, Hsin-Chu City (TW)

Correspondence Address: NAIPO (NORTH AMERICA INTERNATIONAL PATENT OFFICE), P.O. BOX 506, MERRIFIELD, VA, 22116, US

(21) Appl. No.: 10/065,715

(22) Filed: Nov. 13, 2002

(30) Foreign Application Priority Data
Dec. 12, 2001 (TW) 090221833

(51) Int. Cl. B65G 11/00

(52) U.S. Cl. 193/2 R

(57) ABSTRACT

The present invention is a chute positioning apparatus. Two suitable places of two contour lines of top and bottom sides of a positioning board have two rows of chutes. Each chute is a strip open. A half of the chute is a loading and unloading section with a big open, an end of the loading and unloading section connects to an oblique guide board inclined toward chute. Another half of chute is a tightening section with a small open. Two adjacent sides of the two chute rows both are lines, which means each chute of one row is the same height as others, another row is the like. Two suitable places of two ends of a lower contour line of the positioning board have their own guide board, each guide board is fixed on positioning board and vertically and externally protrudes to form a flat base. To use the guide board and the oblique guide piece to guide fixing piece coming in and going out from chute for easily loading and unloading a sub-PCB box and promoting the efficiency of assembly and maintenance.

### BACKGROUND OF INVENTION

1. Field of the Invention

The present invention is related to a positioning apparatus, and more especially to a chute positioning apparatus.

2. Background of the Invention

Recently, the high technical industry has been fully developed in many fields, further rapidly to some other related products. To satisfy the requests from different applications, those products may be added additional functions. Therefore the products are designed to reserve several externally connecting slots; on the other hand, to reach the current of small product, these connecting slots may be installed within a limited room, such as display device, which is occupied by projection system, and thus its inside room is relatively smaller if more systems are put into. Hence, how to figure out the inconvenience of assembly and maintenance is an important issue.

Referring to FIG. 1, it is a display device 1 in prior art. The display device 1 is designed a panel 11 on a front end of a base 10, above the panel 11 is a screen 12, behind the screen 12 is a projection system 13, the projection system 13 is on top of a back case 14, the back case 14 is on rear side of the base 10 and adjacent to a rear part of panel 11, further back case 14 has a control device 15 on the inside and a sub-PCB box 16 is fixed on a rear side surface of the control device 15.

Referring to FIG. 2, a schematic diagram shows a sub-PCB box 16 fixed on aforesaid display device 1 in prior art. For display device 1, there are several screw holes (not shown in the figure) on a side of the control device 15. Positions on a flange 161 of the sub-PCB box 16 corresponding to the screw holes have other screw holes as well. A plurality of screws 162 go through the screw holes on the flange 161 of sub-PCB box 16, and then lock up on the screw holes on the side of control device 15 for fixing the sub-PCB box 16 on the side of control device 15. The way to lock up screws may need room enough to handle a screwdriver, but supplementary devices for additional functions on back case 14 occupy the most space, and it makes that to handle a screwdriver is difficult. Especially that maintenance operation must be operated via a limited window on back case 14 when the additional functions are optional. Because the window is too small to process operations, even the operation must be implemented by experience or sensation in a sightless situation such that reduce the efficiency of assembly or maintenance.

Referring to FIG. 3, to solve the above problems, another prior art shows that two-row fixing slots 30 are on an upper and a lower side of control device 115. One end of each fixing slot 30 is a big open 301 for loading and unloading; another end is a small open 302 for locking up. A side 303 of each fixing slot 30 is shaped as a horizontal line, each side 303 on upper side is the same height, and other sides 303 on lower side are the same. Positions on two sides of a bottom surface of sub-PCB box 16 corresponding to those fixing slots 30 of control device 15 are set plural fixing pieces 40 toward outside. When assembly, the fixing pieces 40 inserts into the big open 301 and moves to the small open 302 for settling. Using flexible force, each metal fixing piece 40 may hook up control device 15 for positioning sub-PCB box 16. Though the way to lock up has no need for big room, to move sub-PCB box 16 on fixing slots 30 back and forth or up and down several times still can be happened under the condition of a limited room and unclear vision. Thus, to hook up fixing pieces 40 simultaneously may depend on touching feeling by a hand or two hands. On the other hand, to move fixing pieces 40 from small opens 302 to big opens 301 shall be synchronous when unloading sub-PCB box 16. As always, fixing pieces 40 often hook up edges of fixing slots 30 for not smoothly taking sub-PCB box 16 off. Therefore, the way is obviously nothing with that rapidly loading and uploading.

### SUMMARY OF INVENTION

An object of the present invention is to provide a chute positioning apparatus with a guide board to rapidly and precisely guide a sub-PCB box to a control device for promoting the efficiency of assembly and maintenance.

Another object of the present invention is to provide a chute positioning apparatus with an oblique guide piece to rapidly take a sub-PCB box off from a control device for promoting the efficiency of assembly and maintenance.

To reach aforesaid objects, the present invention adopts that two suitable positions on two contour lines of top and bottom sides of a positioning board are set two rows of plural chutes. Each chute is a strip open, and a half of the chute is a big open for loading and unloading, an end of the big open connects to an oblique guide board, which is inclined toward the chute; another half of the chute is a small open for locking up, two adjacent sides of the two-row chutes are on their own horizontal lines, which means each side of the chutes for each row is on the same height, further, two suitable positions of two ends of a lower contour chute row on the positioning board are mounted two guide boards, one of each, each guide board fixed on the positioning board protrudes externally along a vertical direction, then a flat base is formed. As a conclusion, to guide fixing pieces into chutes via guide boards and oblique guide boards.

### BRIEF DESCRIPTION OF DRAWINGS

The appended drawings will provide further illustration of the present invention, together with description; serve to explain the principles of the invention.

FIG. 1 is a perspective view of a display device in prior art.

FIG. 2 is a schematic diagram of a sub-PCB box fixed on aforesaid display device in prior art.

FIG. 3 and FIG. 4 are perspective views of a sub-PCB box structure in prior art.

FIG. 5 is a perspective view of a chute of a control device of the present invention.

FIG. 6 is a perspective view of a sub-PCB box of the present invention.

FIG. 7 is a perspective view of the fixed sub-PCB box of the present invention.

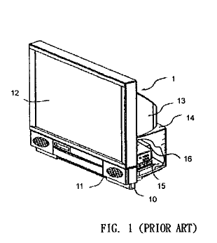

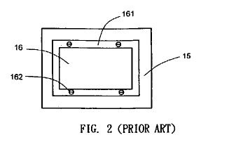

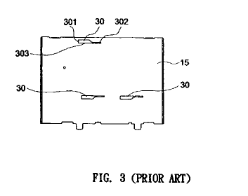

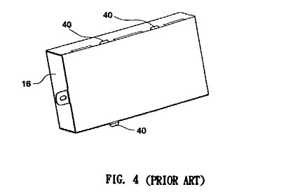

### DETAILED DESCRIPTION

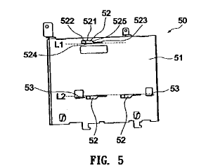

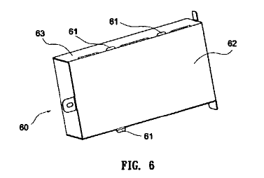

Referring to FIG. 5, the chute positioning apparatus 50 has two rows of plural chutes 52, which are on two suitable positions of two contour lines L1 and L2 of top and bottom sides of a positioning board 51. Each chute 52 is a strip open, a half of chute 52 is a loading and unloading section 521 with a big open, and an end of the loading and unloading section 521 connects to an oblique guide piece 522 internally inclined toward chute 52. The length of the oblique guide piece 522 is a third of the length of the loading and unloading section 521, and its width is equal to the width of loading and unloading section 521. Another half of chute 52 is a tightening section 523 with a small open. Two adjacent sides 524 for two rows of chutes 52 both are on their own lines, that means each line is formed by plural sides of chutes 52 for one row, and the line is horizontal. On the other side, an oblique guide side 525 may connect a place between loading and unloading section 521 and the tightening section 523. Two suitable places of the contour line L2 on the positioning board 51 have two guide boards 53 fixed on positioning board 51 and protruding along a vertical direction for forming a flat base. Referring to FIG. 6, on two sides of a bottom surface 62 of a sub-PCB box 60, plural places corresponding to chutes 52 are fit a plurality of protruding positioning pieces 61. The length of positioning piece 61 is a little shorter than the width of loading and unloading section 521 so as to insert into loading and unloading section 521.

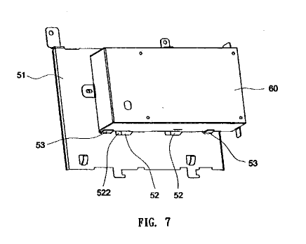

Referring to FIG. 7, when assembling the present invention, the bottom surface 62 of the sub-PCB box 60 is against to positioning board 51, a bottom side surface 63 of sub-PCB box 60 is placed on two guide boards 53, and further to tightening section 523. By means of the guidance of a certain height of two guide boards 53, plural fixing pieces 61 of sub-PCB box 60 can be ensured to move with the same height as loading and unloading section 521 and smoothly insert into chutes 52 via oblique guide pieces 522, thus the fixing pieces 61 can be embedded into tightening sections 523 along the oblique guide side 525. To use flexible force of each metal fixing piece 61 to hook up internal sides of tightening section 523 for fastening sub-PCB box 60. On the other hand, for unloading sub PCB box 60, to pull fixing piece 61 out from tightening section 523 to loading and unloading section 521, when fixing piece 61 meets oblique guide piece 522, fixing piece 61 can then come out via the moving height of guide board 53 guiding sub-PCB box 60 and oblique guide piece 522 inclined toward outside. It is to avoid that fixing piece 61 being blocked by a side of chute 52. As a result, even a window on back case 14 being too small and without a straight vision, to load and unload sub-PCB box is then an easy way from the present invention. It is to absolutely promote the efficiency of assembly and maintenance.

The theory of the present invention is not restricted by the embodiment of sub-PCB box 60, other additional functions or the devices for combining and fastening are suitable of the spirit of the present invention. Furthermore, positioning board 51 of the present invention can be an independent device or is directly formed on a main device. Both of them may belong to the category of the theory of the present invention.

It is to be understood that the above description covering some of the preferred embodiments of the present invention shall not be based to restrict or limit the range of applicability of the present invention, and that all modifications or variations made without departing from the spirit of the invention shall be included in the subject claim.

What is claimed is:

1. A chute positioning apparatus comprising:
a positioning board;
a plurality of chutes forming in the positioning board, at least one of the chutes having a loading and unloading section and a tightening section, an open of the loading and unloading section is greater than an open of the tightening section;
a plurality of guide boards vertically mounting on positioning board and externally protruding to form a guide surface.

2. The chute positioning apparatus of claim 1, wherein an end of the chute in the loading and unloading section connects to an oblique guide piece inclined toward chute.

3. The chute positioning apparatus of claim 1, wherein the chutes are on two contour lines of top and bottom sides of the positioning board.

4. The chute positioning apparatus of claim 3, wherein the guide boards are on two ends of a lower contour lines of two chute rows.

5. The chute positioning apparatus of claim 1, wherein the positioning board is able to form on a main device.
